(19) United States
(12) Patent Application Publication
(10) Pub. No.: US 2015/0325097 A1
(43) Pub. Date: Nov. 12, 2015

(54) SMART CANISTER

(71) Applicants: Air Liquide Electronics U.S. LP, Dallas, TX (US); American Air Liquide, Inc., Fremont, CA (US)

(72) Inventors: Ashutosh MISRA, Plano, TX (US); Benjamin J. JURCIK, JR., Landenberg, PA (US)

(21) Appl. No.: 14/801,789

(22) Filed: Jul. 16, 2015

(51) Int. Cl. G08B 21/18

(52) U.S. Cl. CPC G08B 21/18

(57) ABSTRACT

Disclosed are smart canisters for use in the materials industry. The smart canisters include sensors and communication devices that allow users to continuously monitor various physical and chemical properties of the product insider the canisters. For a variety of products that have limited stability and tend to decompose over time, variations in product properties can adversely impact the process in which the material is used. The smart canister can alert the user, in real time, when the product is starting to deviate from pre-set functional parameters.

### TECHNICAL FIELD

Disclosed are smart canisters for use in the materials industry. The smart canisters include sensors and communication devices that allow users to continuously monitor various physical and chemical properties of the product insider the canisters. For a variety of products that have limited stability and tend to decompose over time, variations in product properties can adversely impact the process in which the material is used. The smart canister can alert the user, in real time, when the product is starting to deviate from pre-set functional parameters.

### BACKGROUND

Product tracking and quality monitoring is important in any industry. Quality maintenance is of critical importance in the semiconductor, photovoltaic, LCD-TFT, flat panel-type device, refractory material, and aeronautic industries. Connecting a product of sub-par quality to a fab may result in millions or even billions of dollars of wasted resources. Typically, product analyses are performed after synthesis and the product shipped to the fab. Little to no information as to the quality of the product is available after its arrival at the fab and prior to connection of the product to the fab infrastructure.

Canisters having tracking and level, pressure, or temperature sensors are known. See, e.g., U.S. Pat. No. 5,126,729 to Nalco Chemical Company; U.S. Pat. Nos. 8,047,079, 8,359,171, and 9,062,908 to L'Air Liquide Société Anonyme pour l'Etude et l'Exploitation des Procédés Georges Claudes. However, depending on the product, decomposition may occur independent of any variances in product level or temperature. Such decomposition may result from the inherent chemical structure of the product, where, over a period of time it may, for example, tend to polymerize, hydrolyze, forming unwanted species that are detrimental to its performance in the intended application. Such products may be used in applications including, but not limited to, deposition of thin films by techniques like chemical vapor deposition (CVD), atomic layer deposition (ALD), physical vapor deposition (PVD), plasma enhanced chemical vapor deposition (PECVD), plasma enhanced atomic layer deposition (PEALD), spin on deposition (SOD), and electrochemical deposition (ECD).

U.S. Pat. No. 6,543,493 to American Air Liquide, Inc. and L'Air Liquide—Société Anonyme à Directoire et Conseil de Surveillance pour l'Etude et l'Exploitation des Procédés Georges Claude discloses methods and apparatuses of measuring both concentration and amount of a liquid in a liquid chemical canister. The method includes the steps of: (a) viewing light emanating from a first optical member that is in visual contact with the liquid, the light emanating from the optical member having a level indicating quality; and (b) routing light from a second optical member that is in visual contact with the liquid to means for optical discrimination between liquid chemical based on different optical properties.

U.S. Pat. No. 6,577,988 to IBM discloses a monitoring system for monitoring gas delivery systems from a Web browser. The system collects data generated from existing gas delivery systems, as well as other information, such as maintenance and repair data, and stores the data in a database located on a centralized server computer system. An authorized user may access the database from a remote location, check the status of the gas cylinders, manifolds, and tools, and generate reports including mean-time-to-failure reports, serviceability, comparisons among buildings or sites, thus saving time and helping to minimize future downtime of the gas delivery system. In addition, the monitoring system automatically monitors the gas delivery system for critical conditions and automatically notifies appropriate personnel of conditions that require immediate attention.

A need remains for smart canisters that disclose the location of a canister and predict when the product contained therein will no longer be suitable for its intended purpose.

### NOTATION AND NOMENCLATURE

Certain abbreviations, symbols, and terms are used throughout the following description and claims, and include:

As used herein, the indefinite article “a” or “an” means one or more.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a side-cross-section diagram of one embodiment of the disclosed smart canister;

FIG. 2 is a schematic side-cross-section diagram of another embodiment of the disclosed smart canister;

FIG. 2a is a schematic side-cross-section diagram of the light path through optical sensor 14 in FIG. 2 when the product level in canister 2 is above facets 24 and 26;

FIG. 2b is a schematic side-cross-section diagram of the light path through optical sensor 14 in FIG. 2 when the product level in canister 2 is below facets 24 and 26;

FIG. 3 is a schematic side-cross-section diagram of another embodiment of the disclosed smart canister; and

FIG. 4 is a schematic side-cross-section diagram of another embodiment of the disclosed smart canister.

### SUMMARY

Disclosed are smart canisters comprising a canister capable of containing a product; a quality sensor which monitors the quality of the product in the canister, the quality sensor mounted on the canister; and a communication device capable of identifying a location of the canister, mounted on the canister, and in communication with the sensor, the communication device communicating the location of the canister and the quality of the product in the canister. The disclosed smart canisters may include one or more of the following aspects:
the quality sensor being mounted on an interior of the canister;
the quality sensor being in contact with the product contained within the canister;
the quality sensor being mounted on an exterior of the canister;
the quality sensor being a refractive index sensor;
the quality sensor being a speed of sound sensor;
the quality sensor being a thermal conductivity sensor;
the quality sensor being a dissolved oxygen sensor;
the quality sensor being a pH sensor;
the quality sensor being a resistance sensor;
the quality sensor being an opacity sensor;
the quality sensor being a diffraction sensor;
the quality sensor being an absorption spectrum sensor;
the quality sensor being an impedance sensor;
the quality sensor being a redox probe;
the quality sensor being an imaging sensor;
the quality sensor being a surface NMR sensor;
the quality sensor being a coherent anti stokes raman spectroscopy sensor;
the quality sensor being a x-ray fluorescence sensor;
the quality sensor being a particulate sensor;
the quality sensor being an O₂ sensor;
the quality sensor being a gas chromatography-thermal conductivity detector;
the quality sensor being a Raman spectroscopy sensor;
the quality sensor being a colorimetry sensor;
the quality sensor being a surface tension sensor;
the quality sensor being an anion probe;
the quality sensor being a surface Plasmon resonance sensor;
the quality sensor being a viscosity sensor;
the smart canister further comprising a temperature sensor;
the smart canister further comprising a pressure sensor;
the communication device including a Global Position Device mounted on the canister;
the Global Position Device including built-in memory containing the characteristics of the canister;
the communication device including a NFC/RFID tag mounted on the canister;
the NFC/RFID tag being an active RFID tag containing the characteristics of the canister;
the communication device including a Global Position Device and a NFC/RFID tag mounted on the canister;
the communication device including a Global Position Device, a NFC/RFID tag mounted on the canister, and memory;
the quality sensor and communication device being separate components;
the quality sensor and communication device being integrated components;
the product being pentakis(dimethylamino)tantalum and the quality sensor being a light sensor which measures diffraction and/or reflection angles of any particulate matter in a vapor phase of the canister;
the product being RuO₄ and the quality sensor being an oxygen sensor which measures oxygen concentration in the canister; and
the product being ZnEt₂ and the quality sensor being a light sensor which measures diffraction and/or reflection angles of any particulate matter in a liquid phase of the canister;
the product being ZnEt₂ and the quality sensors being a light sensor which measures diffraction and/or reflection angles of any particulate matter in a liquid phase of the canister and a thermal conductivity sensor which measures a concentration of ethane in a vapor phase of the canister.

Also disclosed are methods for a product supplier to maintain product quality after shipment of a product. The product is introduced into a canister having a quality sensor adapted to monitor a quality of the product in the canister and a communication device adapted to identify a location of the canister. A quality analysis of the product is routinely performed using the quality sensor and the results of the quality analysis are transmitted via the communication device to the product supplier. The disclosed methods may include one or more of the following aspects:
the quality sensor being mounted on an interior of the canister;
the quality sensor being in contact with the product contained within the canister;
the quality sensor being mounted on an exterior of the canister;
the quality sensor being a refractive index sensor;
the quality sensor being a speed of sound sensor;
the quality sensor being a thermal conductivity sensor;
the quality sensor being a dissolved oxygen sensor;
the quality sensor being a pH sensor;
the quality sensor being a resistance sensor;
the quality sensor being an opacity sensor;
the quality sensor being a diffraction sensor;
the quality sensor being an absorption spectrum sensor;
the quality sensor being an impedance sensor;
the quality sensor being a redox probe;
the quality sensor being an imaging sensor;
the quality sensor being a surface NMR sensor;
the quality sensor being a coherent anti stokes raman spectroscopy sensor;
the quality sensor being a x-ray fluorescence sensor;
the quality sensor being a particulate sensor;
the quality sensor being an O₂ sensor;
the quality sensor being a gas chromatography-thermal conductivity detector;
the quality sensor being a Raman spectroscopy sensor;
the quality sensor being a colorimetry sensor;
the quality sensor being a surface tension sensor;
the quality sensor being an anion probe;
the quality sensor being a surface Plasmon resonance sensor;
the quality sensor being a viscosity sensor;
further comprising performing an initial quality analysis of the product prior to its placement in the canister;
performing the initial quality analysis using a different analysis technique than that of the quality sensor;
comparing the results of the quality analysis routinely performed using the quality sensor to the initial quality analysis;
identifying and transmitting a location of the canister to the product supplier via the communication device when the quality analysis fails;
transmitting the results of the quality analysis to a memory device;
performing data analysis of the results of the quality analysis stored in memory to predict when product failure will occur;
monitoring a quantity of product remaining in the canister and prompting the product supplier to send a replacement canister when the quantity nears depletion; and
notifying a product recipient when the quality analysis fails.

### DETAILED DESCRIPTION OF PREFERRED EMBODIMENTS

Disclosed are smart canisters for use in the materials industry. The smart canisters include communication devices that identify the location of the canister and quality sensors that perform a quality measurement of the product. The sensors help to predict when to stop using the canister due to any problems with the product stored therein. The sensors help to ensure that the product contained therein is still suitable for its intended purpose during canister use. The communication device helps to locate the canister when the sensors identify that the product is no longer suitable for its intended purpose. The communication device and/or the sensor may communicate with the recipient of the canister, the product supplier, or both. This combination of the communication device and quality sensor makes it possible to achieve the sought-after differentiation and therefore the sought-after effectiveness.

The canister may be any vessel capable of containing a gas, liquid, or solid. Typical canisters are constructed of low-carbon steel. To attain the required purity levels and service life demanded in the semiconductor industry, the low-carbon steel may require special materials of construction or further treatment to minimize metal contamination from the cylinder walls. For example, the internal steel surfaces of the cylinder may be polished and baked to remove contaminants and residual moisture. Electro polishing using a chromium-rich electroplating solution may also be used to produce an interior canister surface layer with reduced iron and increased carbon and chromium. Alternatively, an electroplated nickel or nickel-phosphorous layer may be formed on the internal surfaces of a steel cylinder.

The canister may be any size suitable for transport of the product. One of ordinary skill in the art will recognize that the size may be small, for less stable products or those that are used less frequently in the intended process, ranging from 100 mL to 500 mL. Alternatively, for more stable products or those that are used more frequently in the intended process, canisters may be larger, ranging from 100 L to 200 L. If needed, intermediary sized canisters may also be used.

The quality sensor measures any product quality that would demonstrate degradation of the product. The quality sensor may include a recorder transponder making it possible to store the sensor results at a frequency defined as a function of the requirements for a determined time as well as a database containing the characteristics of the canister. The quality sensor communicates its results via a communication device with the recipient of the canister, the product supplier, or both. This may be achieved by either a micro GPS that is built into the sensor as part of an integrated sensor design, or as a combination of a sensor and a micro GPS that serves the purpose of not only measuring the relevant property of the contents inside the canister, but also communicating such information. The sensor may transmit the test results and canister location using any known and available modes of transmission. Alternatively, the sensor may be integrated in or connected to a distributed control system. The distributed control system may convert analog sensor results to digital format using any known commercial analog-to-digital converters. The distributed control system may include memory on which to store the testing results along with the date and time of the test. The memory may also be programmed to include the canister location, canister serial number, product Safety Data Sheet (SDS, formerly known as Material Safety Data Sheet, or MSDS), the initial fill quantity, the certificate of analysis, and/or the product expiration date. The distributed control system may transmit the test results and any associated data using any known and available modes of transmission. For example, the distributed control system may communicate directly with the customer's Programmable Logic Controller (PLC) or Supervisory Control and Data Acquisition (SCADA) system. Additionally or alternatively, the digital control system may communicate with the product supplier's computer system.

Exemplary quality sensors are known in the art and include refractive index; speed of sound; thermal conductivity; dissolved oxygen; pH; resistance; opacity; diffraction; absorption spectrum (from UV to infrared and all the bands in between); impedance; redox probe; imaging of solid surface (i.e. granulometry of a solid on the bottom of a pan coupled with image analysis); surface NMR sensor; CARS (coherent anti stokes raman spectroscopy); x-ray fluorescence; particulate sensor; O₂ sensor; gas chromatography-thermal conductivity detector; Raman spectroscopy; colorimetry; surface tension; anion probes; surface Plasmon resonance; viscosity; or combinations thereof. A temperature sensor may also be used if the product is temperature sensitive. If the product is stored in a pressurized canister, a pressure or capillary pressure sensor may also be used. Sensors for monitoring the above listed parameters individually, or in combination, are also referred to as “Lab on a Chip” in the literature, which implies miniaturization of sensors to a form factor that makes them highly versatile for applications where not much space is available. In other words, a Lab-On-A-Chip is equivalent to a fully functional analytical laboratory capable of measuring a variety of physical and chemical properties, except that it is built on micro-chips where the sensors are part of the chip itself.

These quality sensors may be in physical contact with the contents of the canister in order to measure the properties of the product. Alternatively, these quality sensors may be mounted on the exterior of the canister where the sensor does not come in physical contact with the product and measures the properties via signal propagation through the canister walls and through the contents of the canister. In another alternative, a mixture of quality sensors may be used, with some in contact with the product and others not.

Suitable quality sensors may be purchased off-the-shelf. Alternatively, if the quality sensor contains any parts that will degrade the product on contact therewith or become degraded by contact with the product, sensors may be designed having suitable product/sensor interfaces. For example, a commercially available sensor may be redesigned so that all product/sensor interfaces are made using ceramic, inconel, stainless steel, or any other material which permits the sensor to perform its function without degrading the sensor, performance of the sensor, or contamination or otherwise impacting the quality of the material in the canister.

As mentioned above, the communication device may be a micro GPS that is either combined with or integrated into the sensor. Alternatively, the communication device may be a NFC/RFID Tag in direct communication with the recipient of the canister. In yet another alternative, the communication device may be a global position device (GPD), which broadly encompasses the previously referenced micro GPS as well as any commercially available GPDs, such as those sold by Wintec Co., Ltd., Globalsat Worldcom Corp., Visiontac Instrument Inc., or Qstarz International Co., Ltd. These companies, and similar companies, produce many different GPD technologies suitable for use in the present invention. The communication device is designed to communicate with the recipient of the canister, the product supplier, or both. The product contained in the canister as well as the location of the communication device on the canister help to determine whether to pursue a “micro” design, for example, if the GPS needs to be incorporated into the sensor due, for example, to a small canister size, or whether a non-micro embodiment may be used, for example, on a larger canister.

It will be recalled that the literature speaks equally of NFC (Near Field Communication) and RFID (for Radio Frequency IDentification) “Tag” or “chip” or “microchip”.

Not too much consideration will be given here to these devices which are well known to the person skilled in the art, which are well catalogued and commercially available in multiple forms:
The NFC/RFID Tags are termed “passive” when they are not furnished with their own battery or cell or energy source, so they cannot emit data by themselves without having been invoked by an antenna that activated them (antenna of the reading apparatus which emits a radio signal to activate and identify the Tag, and to write or read data).

These passive Tags contain on the other hand a sort of electronic signature able to be transmitted to a supervision system when the Tag is invoked.

However, in practice their range is very low (less than 2 meters).
The NFC/RFID Tags are termed “active” when conversely they are furnished with their own energy source (battery), and therefore capable of emitting by themselves, even without being invoked to do so.

On the other hand their range can commonly reach a hundred meters.

The active Tag advantageously comprises a recorder transponder making it possible to store a database containing the characteristics of the canister. For example, the active Tag may include the canister serial number, product Safety Data Sheet (SDS, formerly known as Material Safety Data Sheet, or MSDS), the initial fill quantity, the certificate of analysis, and/or the product expiration date.

The communication device may also include software that permits the canister to have the capability of auto-regulating itself. For instance, the product supplier may define control limits that trigger commands to the canister to regulate its operation. As an example, if the viscosity of the material inside the canister, as measured by the quality sensor, exceeds the defined upper limit, the pneumatic valve on the canister may be automatically actuated to go into a shut mode so as to prevent delivery of degraded material to the process. This regulation may not be limited to a full shut off of a valve, but could also include other commands, such as a control signal to a mass flow controller (MFC) to alter product flow based on user defined parameters.

One of ordinary skill in the communications arts would be capable of establishing communication between the communication device and intended recipients, as well as how to tailor communications to the intended recipient. In other words, in one exemplary communication style, the product owner may receive all test results, whereas the product recipient may only receive an alert when the test results are either approaching an out of specification reading or after the results are out of specification.

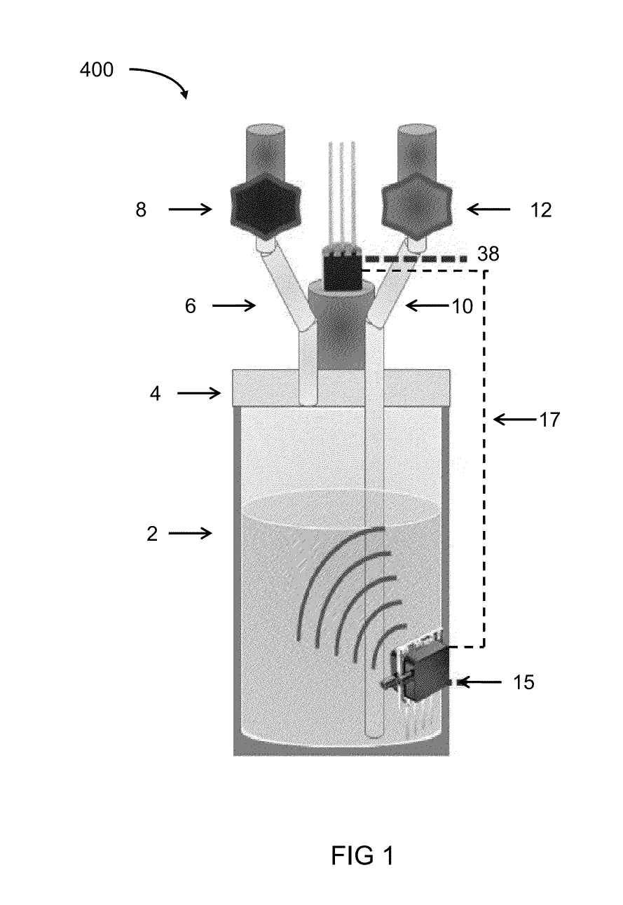

Referring now to the drawing figures, FIG. 1 illustrates a generic embodiment of the disclosed smart canister 400. Apparatus 400 includes a canister 2 having a canister top 4, a liquid inlet conduit 6 and control valve 8, and a liquid chemical outlet conduit 10 and control valve 12. Apparatus 400 also includes a quality sensor 15 and a communication device 38, which communicate via line 17. In FIG. 1, the quality sensor 15 is illustrated as an acoustic or ultrasound wave sensor, which can measure an increase in particles or changes in viscosity or pressure in a gas or fluid, as well as product volume. Acoustic or ultrasound wave sensors may also be designed to detect specific chemical vapors and, as a result, may detect degradation products. The communication device 38 may be any of the devices discussed above, and includes location tracking and memory to store canister serial number, product Safety Data Sheet (SDS, formerly known as Material Safety Data Sheet, or MSDS), the initial fill quantity, the certificate of analysis, the product expiration date, and/or any other information that may be important.

In one exemplary embodiment, the smart canister contains pentakis(dimethylamino)tantalum (“PDMAT”). PDMAT is a solid product. Vaporization of solids includes many known complications, including the potential for particulate matter in the vapor phase. Particulate matter in the vapor phase is detrimental to deposition processes. A smart canister containing PDMAT may include a light sensor which measures the diffraction and/or reflection angle of any particulate matter in the vapor phase of the canister. The light sensor monitors the vapor phase and communicates the results to the communication device. Testing may be used to establish when the particulate level in the vapor phase is too high. The communication device may communicate when this level is reached to the product recipient, product manufacturer, or both.

The smart canister may also help with inventory control. In the exemplary embodiment above, the product manufacturer may receive communications from the smart canister via the communication device that the customer has begun to use the product, for example, based on an increase in the amount of particulate matter in the vapor phase. Depending on the size of the canister, the product manufacturer may prepare and ship a replacement smart canister based on historical data as to when the particulate level will reach unacceptable levels, so that the customer always has product having proper quality available.

In another exemplary embodiment, the smart canister contains RuO₄ product. The RuO₄ product may be in solid form or in solution. When RuO₄ decomposes, it produces RuO₂ and O₂. The smart canister may include an oxygen sensor to monitor any increase in O₂ level. For example, if the smart canister is inadvertently exposed to conditions that increase the degradation rate of RuO₄, such as heat, the O₂ sensor may alert the product supplier via the communication device. The product supplier may then intercept delivery of the product before it reaches the customer and have it replaced with RuO₄ product having quality suitable for the intended purpose.

In another exemplary embodiment, the smart canister contains ZnEt₂ product. ZnEt₂ is a liquid product. Similar to the PDMAT example, a light sensor may be used to monitor the particulate level, but in the liquid product itself rather than in the vapor phase. A thermal conductivity sensor may also be used to monitor the level of ethane produced in the vapor phase.

In another exemplary embodiment, the sensor may be a fiber optics sensor, as disclosed in U.S. Pat. No. 6,543,493 to American Air Liquide, Inc. and L'Air Liquide—Société Anonyme à Directoire et Conseil de Surveillance pour l'Etude et l'Exploitation des Procédés Georges Claude. Optical transmission/reflection phenomena are monitored by means of simple fiber optics. By examining spectral profiles of light transmitted or reflected by the chemical, one can assess the purity of the liquid chemical inside the canister by the presence or absence of impurities, as impurities will typically change (for example, darken) the color of the liquid chemical, or other optical properties. The fiber optics may also provide an indication of the level of chemical remaining in the canister.

A single optical feed through connection may be made preferably on or near the top of the canister, and light propagation directed perpendicularly to the liquid surface. Using more sophisticated spectral interpretation of light from the fibers, both liquid level and chemical purity may be assessed. Such installation minimizes manufacturing costs as well as limits the number of canister seals required, thereby reducing potential sites for leaks and chemical degradation from sealing materials required in the optical connections to the canister.

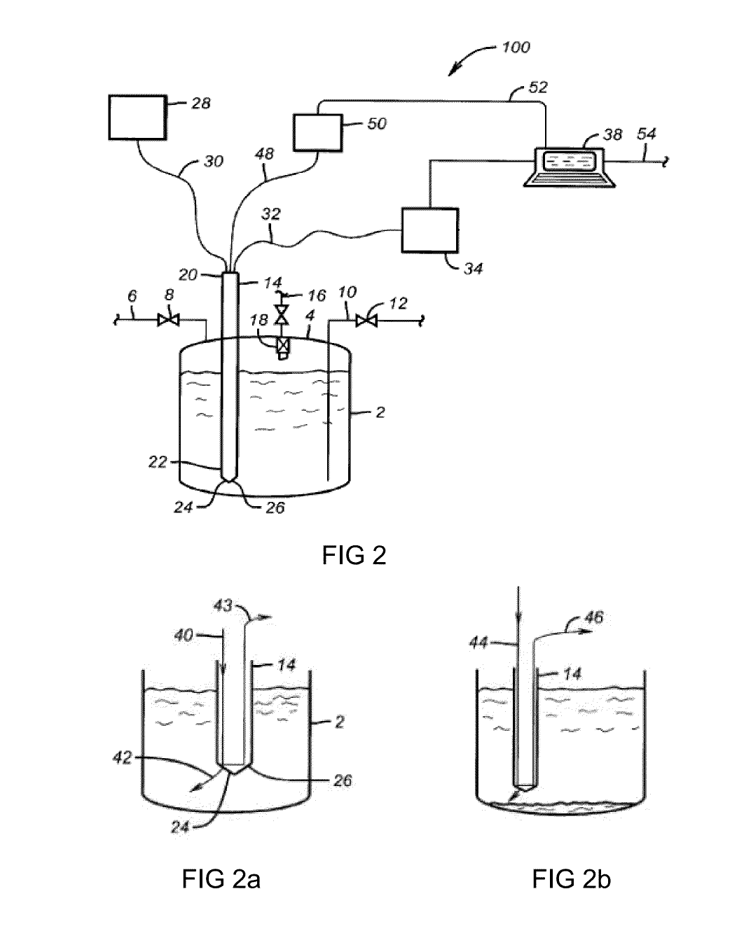

FIG. 2 illustrates another embodiment 100 of an apparatus in accordance with the fiber optic embodiment invention. Apparatus 100 includes a canister 2 having a canister top 4, a liquid inlet conduit 6 and control valve 8, and a liquid chemical outlet conduit 10 and control valve 12. Present is an optical element 14, an optional gas inlet 16 with gas filter 18, gas filter 18 preferably comprising gas filter media such as alumina, silica and aluminosilicates. Optical member 14 has a proximal end 20 and a distal end 22, distal end 22 having a pair of facets or faces 24 and 26. A light source 28 is connected via an optical transmitter, such as an optical fiber 30 which connects light source 28 with optical member 14 at its distal end 20. Another optical fiber 32 connects optical member 14 at its distal end 20 to a spectrometer 34. Spectrometer 34 is connected to the communication device 38.

Referring now to FIGS. 2A and 2B, the functions of optical member 14 and its construction will be described. A light ray 40 entering optical member 14, will reach facet 24, producing a light ray 42 as depicted in FIG. 1A. In other words, very little of the light ray 40 will be reflected back towards the light source 28. This information is important in determining the presence or absence of liquid chemical within canister 2. A light ray 43 may emanate from facet 26 and traverse in the opposite direction as light ray 40 through optical member 14, and exit through an optical fiber 48 (FIG. 2) and into a light receptor 50. Light receptor 50 is able to tell the presence or absence of liquid in canister 2. Simultaneously, light ray 43 or a separate light ray emanating from optical member 14 is fed through optical fiber 32 into spectrometer 34, and the concentration of liquid chemical thus determined by spectroscopic analysis.

FIG. 2B illustrates the situation when liquid level drops below the level of the facets 24 and 26 of optical member 14. In this case an incoming light ray 44 is substantially totally reflected by facets 24 and 26 and thus exits light member 14 as light ray 46. Light ray 46 is much more intense than light ray 43 of FIG. 2A, and is routed via optical fiber 48 to optical receptor 50. Further, either ray 46 or a separate light ray (not shown) in FIG. 2B is fed through optical fiber 32 to spectrometer 34.

Thus the apparatus of FIGS. 2, 2A, and 2B is able to simultaneously determine liquid level and concentration of liquid chemical in canister 2. This information is fed to communication device 38 and further communicated via 54 to the product owner, the product recipient, or both. Communication device 38 includes the global position device as well as any product information, such as canister serial number, product Safety Data Sheet (SDS, formerly known as Material Safety Data Sheet, or MSDS), the initial fill quantity, the certificate of analysis, and/or the product expiration date.

As illustrated, the optical element may be located within the canister 2 and in communication, via optical fibers 30, 32, and 48, with the light source 28, spectrometer 34, light receptor 50, and communication device 38. Light source 28, spectrometer 34, light receptor 50, and communication device 38 may all be located outside the canister 2 and in the same location. The separation of elements illustrated in FIG. 2 is only provided for convenience.

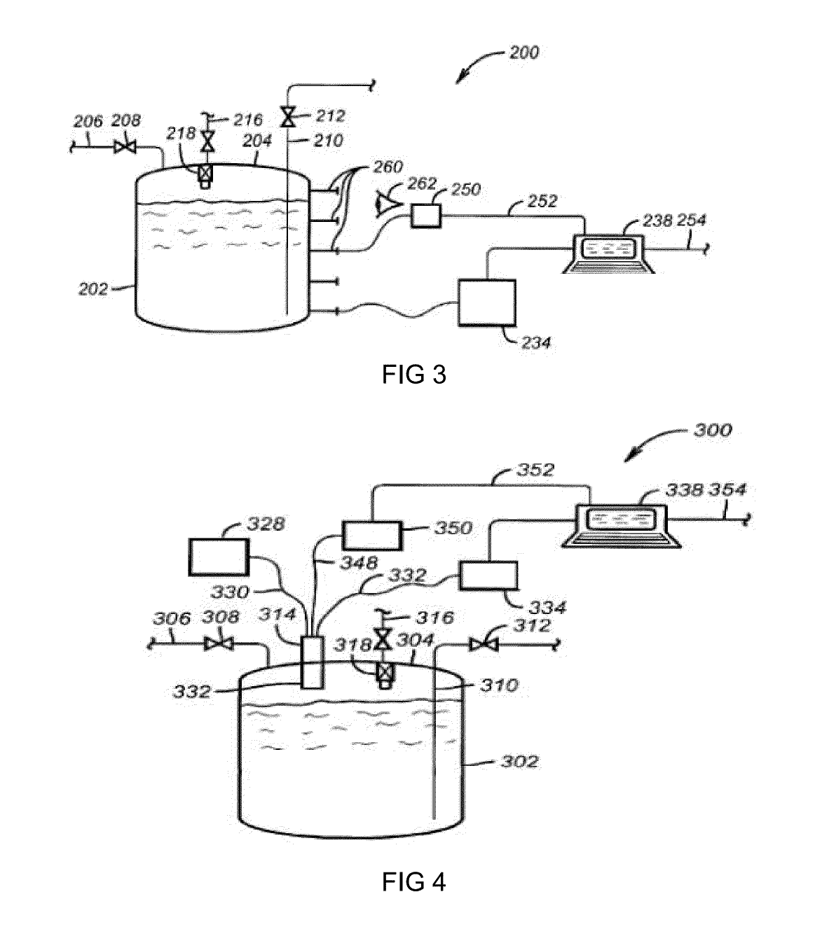

FIG. 3 illustrates a second embodiment 200 of liquid chemical canister in accordance with the invention. Embodiment 200 comprises a canister 202 having a top 204, a liquid inlet 206 and liquid inlet control valve 208. Also present is a liquid discharge conduit 210 and liquid discharge control valve 212. Optionally, canister 202 may be fitted with a gas inlet line 216 which itself has a gas filtration media 218 attached thereto as previously explained in accordance with FIG. 2. In embodiment 200 of FIG. 3, a plurality of light pipes or optical fibers 260 are connected to canister 202 so that both quality and level of liquid within canister 202 can be determined. For example, the quality of liquid within canister 202 may be determined by spectrometer 234, which may be transmitted via communication device 238. Simultaneously, liquid level data may be obtained by a light receptor 250, which may be attached optically to all light pipes or optical fibers 260. Information for light receptor 250 is fed to communication device 238. Preferably, the outputs of light receptor 250 and spectrometer 234 are fed through communication device 238 and further communicated via 254 to the product owner, the product recipient, or both. Communication device 238 includes the global position device as well as any product information, such as canister serial number, product Safety Data Sheet (SDS, formerly known as Material Safety Data Sheet, or MSDS), the initial fill quantity, the certificate of analysis, and/or the product expiration date.

As illustrated, the light pipes or optical fibers 260 may be located outside the canister 202 and in communication with the light receptor 250 and spectrometer 234, and communication device 238. Light receptor 250, spectrometer 234, and communication device 238 may all be located outside the canister 202 and in the same location. The separation of elements illustrated in FIG. 3 is only provided for convenience.

FIG. 4 illustrates another embodiment of an apparatus in accordance with the present invention, illustrating a canister 302 having liquid chemical inlet conduit 306 and control valve 308, and liquid chemical outlet conduit 310 and control valve 312. An optional gas inlet conduit 316 is illustrated, as well as optional gas filtration media cartridge 318. Canister 302 has a top 304, through which an optical member 314 protrudes. While this is similar to the embodiment 100 in FIG. 2, note that distal end 322 does not protrude into or contact liquid within canister 302. Optical member 314 is connected via optical fiber 330 to a light source 328. Light that is transmitted or reflected through optical member 314 indicating liquid level is transmitted through an optical fiber 348 into light receptor 350, which may have an output via connection 352 to communication device 338. Simultaneously, quality determination of liquid within canister 302 may be obtained through optical fiber 332 connected to spectrometer 334. The output of the spectrometer is to the communication device 338.

In the simplest embodiment, as illustrated in FIG. 2, a commercially available fiber optic transmission sensor probe can be attached at or near the top of the canister. Axiom Analytical, Inc., of Irvine, Calif., manufactures fiber-optically coupled single-pass transmission, attenuated total reflectance, and diffuse reflectance probes which can be used in these applications. The probe can be easily optically connected to a spectrometer by means of fiber optics or other light transporting means such as light pipes. The most convenient of spectrometers is to use what is known in the art as a “PC card” spectrometer. Two manufactures of PC card spectrometers are Ocean Optics, Inc. of Dunedin, Fla., and Control Development, Inc. of South Bend, Ind.

Alternatively, as illustrated in FIG. 3, optical fibers can be attached to the sides of the canister; only in this case, one monitors not only light intensity, but also spectral profile via a spectrometer in order to assess quality of the chemical. One can then easily use the fiber optic closest to the bottom of the canister to perform the spectral analysis of the chemical within. This way, fiber optics provides level sensing (via total intensity monitoring) and quality control monitoring (via spectral profile analysis).

In the third embodiment, as illustrated in FIG. 4, an arrangement minimizing the number of optical ports in the canister is presented. The same fiber is used both for level monitoring and spectral analysis monitoring. In this embodiment, a light source propagates substantially perpendicular to the liquid surface. Since density of liquid is so much greater than vapor, and the amount of vapor pressure of many organometallic compounds is so low, the light absorption characteristics of the vapor are negligible to that of the liquid. The effective path length for absorption is defined by depth of liquid. Hence, the amount of absorption relates to liquid level in the canister. One only needs to identify appropriate wavelength(s) characteristics of the compound of interest and correlate liquid depth to absorption. As absorption may be quite strong, proper wavelength selection is preferably off of center to main absorption bands.

Further spectral analysis as to “color” of liquid chemical is best evaluated by examining a ratio of absorption intensities at different wavelengths. As discussed herein, impurities in certain organometallic compounds can cause color and/or turbidity to change and this information can be monitored by examining the spectral profile of the compound.

As of today, there are currently no known liquid chemical delivery systems, inside or outside of the semiconductor manufacturing industry, that have both product tracking and purity monitoring capabilities, and yet chemical purity demands in many industries such as the semiconductor manufacturing industry are extremely high with the reactive nature of the chemicals used.

In particular, it is known that some chemicals such as transition metal complexes exhibit color which can change depending upon the purity of the chemical. By using fiber optical monitoring techniques of the invention, the color and hence the purity of such chemicals can be easily monitored at the same time that the liquid level in and location of such a canister is monitored.

Today, fiber optic sensors are already used on chemical canisters which deliver chemicals to semiconductor manufacturing processes; however, the fiber optics are not designed and are only partially used in the sense that only the intensity of total light is monitored to indicate whether a liquid level is above or below that point where the fiber is installed.

In summary, the present invention improves the art of liquid chemical delivery by providing an ability to track the location of chemical canister while continuously monitoring its quality. What is important to realize is that fiber optics, and other quality sensors, commonly used in liquid delivery systems can be utilized not only for liquid level determination, but also to determine at least one other property, such as purity of the liquid chemical being used, the presence or absence of flame within the canister, or such other hazardous situations.

It will be understood that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

We claim:

1. A smart canister comprising
a. a canister capable of containing a product;
b. a quality sensor which monitors the quality of the product in the canister, the quality sensor mounted on the canister; and
c. a communication device capable of identifying a location of the canister, mounted on the canister, and in communication with the sensor, the communication device communicating the location of the canister and the quality of the product in the canister.

2. The smart canister of claim 1, wherein the quality sensor is mounted on an interior of the canister.

3. The smart canister of claim 2, wherein the quality sensor is in contact with the product contained within the canister.

4. The smart canister of claim 1, wherein the quality sensor is selected from the group consisting of a refractive index sensor; a speed of sound sensor; a thermal conductivity sensor; a dissolved oxygen sensor; a pH sensor; a resistance sensor; an opacity sensor; a diffraction sensor; an absorption spectrum sensor; an impedance sensor; a redox probe; an imaging sensor; a surface NMR sensor; a coherent anti stokes raman spectroscopy sensor; a x-ray fluorescence sensor; a particulate sensor; an O₂ sensor; a gas chromatography-thermal conductivity detector; a Raman spectroscopy sensor; a colorimetry sensor; a surface tension sensor; an anion probe; a surface Plasmon resonance sensor; a viscosity sensor; and combinations thereof.

5. The smart canister of claim 4, further comprising a temperature sensor.

6. The smart canister of claim 4, further comprising a pressure sensor.

7. The smart canister of claim 1, wherein the communication device includes a Global Position Device mounted on the canister.

8. The smart canister of claim 7, wherein the Global Position Device includes built-in memory containing the characteristics of the canister.

9. The smart canister of claim 1, wherein the communication device includes a NFC/RFID tag mounted on the canister.

10. The smart canister of claim 9, wherein the NFC/RFID tag is an active RFID tag containing the characteristics of the canister.

11. A method for a product supplier to maintain product quality after shipment of a product, the method comprising:
Introducing the product into a canister having a quality sensor adapted to monitor a quality of the product in the canister and a communication device adapted to identify a location of the canister; and
Routinely performing a quality analysis of the product using the quality sensor and transmitting results of the quality analysis via the communication device to the product supplier.

12. The method of claim 11, wherein the quality sensor is selected from the group consisting of a refractive index sensor; a speed of sound sensor; a thermal conductivity sensor; a dissolved oxygen sensor; a pH sensor; a resistance sensor; an opacity sensor; a diffraction sensor; an absorption spectrum sensor; an impedance sensor; a redox probe; an imaging sensor; a surface NMR sensor; a coherent anti stokes raman spectroscopy sensor; a x-ray fluorescence sensor; a particulate sensor; an O₂ sensor; a gas chromatography-thermal conductivity detector; a Raman spectroscopy sensor; a colorimetry sensor; a surface tension sensor; an anion probe; a surface Plasmon resonance sensor; a viscosity sensor; and combinations thereof.

13. The method of claim 12, further comprising performing an initial quality analysis of the product prior to its placement in the canister.

14. The method of claim 13, wherein the quality sensor performs a different analysis technique than the initial quality analysis.

15. The method of claim 13, further comprising comparing the results of the quality analysis routinely performed using the quality sensor to the initial quality analysis.

16. The method of claim 11, further comprising identifying and transmitting a location of the canister to the product supplier via the communication device when the quality analysis fails.

17. The method of claim 11, further comprising transmitting the results of the quality analysis to a memory device.

18. The method of claim 17, further comprising performing data analysis of the results of the quality analysis stored in memory to predict when product failure will occur.

19. The method of claim 11, further comprising monitoring a quantity of product remaining in the canister and prompting the product supplier to send a replacement canister when the quantity nears depletion.

20. The method of claim 11, further comprising notifying a product recipient when the quality analysis fails.
